(19) United States
(12) Patent Application Publication
(10) Pub. No.: US 2020/0209685 A1
(43) Pub. Date: Jul. 2, 2020

(54) LIGHTING DEVICE AND DISPLAY DEVICE

(71) Applicant: SHARP KABUSHIKI KAISHA, Sakai City (JP)

(72) Inventor: YOSHITAKE NAKAMURA, Sakai City (JP)

(21) Appl. No.: 16/726,694

(22) Filed: Dec. 24, 2019

Related U.S. Application Data
(60) Provisional application No. 62/786,391, filed on Dec. 29, 2018.

(51) Int. Cl. G02F 1/1335

(52) U.S. Cl. CPC G02F 1/133603; G02F 1/133553; G02F 1/133524

(57) ABSTRACT

A lighting device includes at least one first light source, a light guide plate, and second light sources. The light guide plate includes a first side surface and a light exiting plate surface. The first side surface is opposed to the first light source so that light from the light source enters therethrough. The light entering through the first side surface and traveling through the light guide plate exits through the light exiting plate surface. The second light sources are two-dimensionally arranged on an opposite side from the light exiting plate surface of the light guide plate. The second light sources include light exiting surfaces each having an area equal to or smaller than an area of a light emitting surface of the at least one first light source.

### CROSS REFERENCE TO RELATED APPLICATION

This application claims priority from Provisional Patent Application No. 62/786,391 filed on Dec. 29, 2018. The entire contents the priority application are incorporated herein by reference.

### TECHNICAL FIELD

The technology described herein relates to a lighting device and a display device.

### BACKGROUND ART

Light emitting diodes (LEDs) are widely used for light sources in backlight units for supplying light to liquid crystal display devices. In recent years, backlight units using small LEDs known as mini LEDs or micro LEDs have been known. A direct backlight unit is disclosed in Japanese Unexamined Patent Application Publication No. 2018-37406. The direct backlight unit includes micro LEDs that are two-dimensionally arranged behind a liquid crystal panel. By reducing the LEDs in size, the thickness of the backlight unit can be reduced. Furthermore, local brightness adjustment becomes easier and thus precise brightness adjustment (local dimming) is possible.

To increase definition (or resolution) of the liquid crystal panel, a percentage of light blocking portion in a surface of the liquid crystal panel increase. The light blocking portion is for separating pixel from one another. Light transmissivity of the liquid crystal panel decreases as the definition increases and thus the brightness of the liquid crystal display device decreases. If the brightness of the backlight unit is increased by increasing an amount of light emitted by the LEDs to improve the brightness of the liquid crystal display device, an amount of heat radiated by the LEDs increases and an optical member adjacent to the LEDs may deform. There is a limit in increasing the amount of light emitted by the LEDs. Furthermore, the brightness can be precise adjusted by reducing the size of the LEDs. However, it may be difficult to improve the brightness.

### SUMMARY

The technology described herein was made in view of the above circumstances. An object is to provide precise adjustment of brightness and to improve the brightness.

A lighting device includes at least one first light source, a light guide plate, and second light sources. The light guide plate includes a first side surface and a light exiting plate surface. The first side surface is opposed to the at least one first light source so that light from the light source enters therethrough. The light entering through the first side surface and traveling through the light guide plate exit through the exiting plate surface. The second light sources are two-dimensionally arranged on an opposite side from the light exiting plate surface of the light guide plate. The second light sources include light exiting plate surfaces each having an area equal to or smaller than an area of a light emitting surface of the at least one first light source.

A display device includes the lighting device described in any one of (1) to (7) and a display panel configured to display images using light emitted by the lighting device.

According to the, technology described herein, the precise brightness adjustment is provided and the brightness improves.

### BRIEF DESCRIPTION OF THE DRAWINGS

FIG. 1 is an exploded perspective view of a liquid crystal panel according to a first embodiment of the technology described herein.

FIG. 2 is a cross-sectional view along line II-II in FIG. 1.

FIG. 3 is a plan view illustrating an arrangement of second light sources (small LEDs) housed in a chassis.

FIG. 4 is a magnified view of a section in a box in FIG. 3.

FIG. 5 is a magnified view of a first modification of the second light sources (the small LEDs) in the section in the box in FIG. 3.

FIG. 6 is a magnified view of a second modification of the second light sources (the small LEDs) in the section in the box in FIG. 3.

FIG. 7 is a magnified view of third modification of the second light sources (the small LEDs) in the section in the box in FIG. 3.

FIG. 8 is a magnified view of a fourth modification of the second light sources (the small LEDs) in the section in the box in FIG. 3.

FIG. 9 is an exploded perspective view of a liquid crystal panel according a second embodiment the technology described herein including a first light source (LEDs), a light guide plate, a second light sources (small LEDs), and a chassis.

FIG. 10 is an exploded perspective view of a liquid crystal panel according to a third embodiment of the technology described herein including a third light source (a cold cathode fluorescent lamp), a light guide plate, second light sources (small LEDs), and a chassis.

FIG. 11 is an exploded perspective view of a liquid crystal panel according to a fourth embodiment the technology described herein including a first light source (small LEDs), a light guide plate, second light sources (small LEDs), and a chassis.

FIG. 12 is a plan view of the first light source (the small LEDs) in FIG. 11.

### DETAILED DESCRIPTION

### First Embodiment

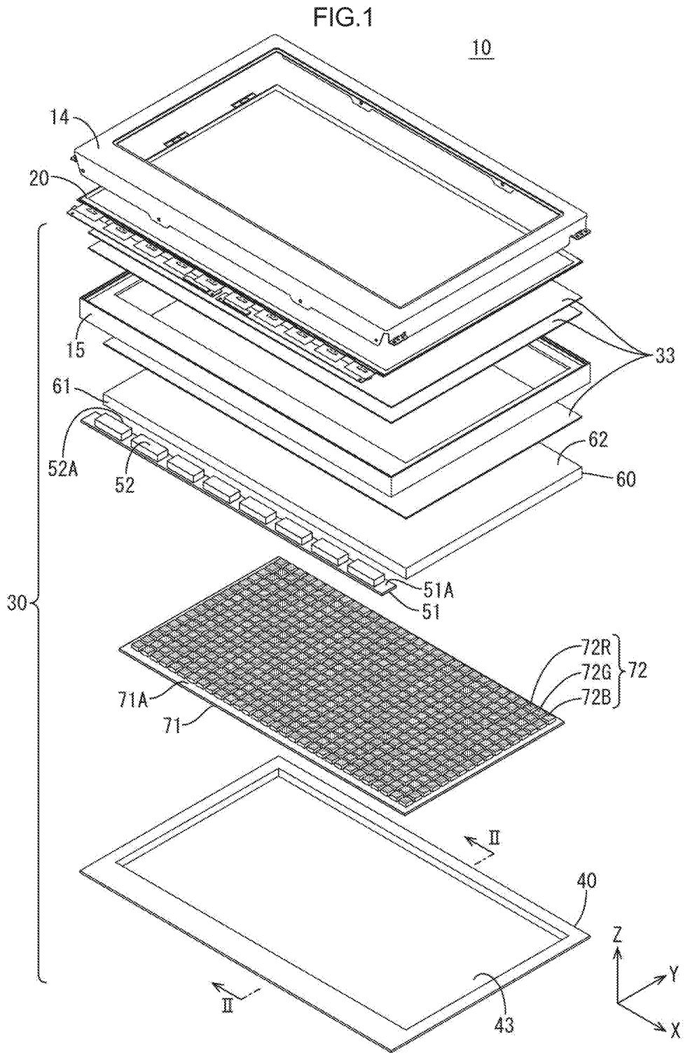

A first embodiment of the technology described herein will be described in detail with reference to FIGS. 1 to 4. In this section, a liquid crystal display device 10 (an example of a display device) including a backlight unit 30 (an example of a lighting device) will be described. In the drawings, X-axes, Y-axes, and Z-axes may be present. The axes in each drawing correspond to the respective axes in other drawings. In the Z-axis direction, a liquid crystal panel 20 side relative to the backlight unit 30 is defined as a front side and an opposite side from the liquid crystal panel 20 side is defined as a rear side.

As illustrated in an exploded perspective view in FIG. 1, the liquid crystal display device 10 includes the liquid crystal panel 20 (an example of a display panel) and the backlight unit 30 (an example of a lighting device). The liquid crystal panel 20 is configured to display images. The backlight unit 30 is configured to illuminate the liquid crystal panel 20 with light. The liquid crystal panel 20 and the backlight unit 30 are collectively held by a bezel 14 having a frame shape. The liquid crystal panel 20 has a horizontally-long rectangular overall shape. The liquid crystal panel 20 includes two glass substrates that are transparent (have high light transmissivity) and bonded together with a predefined gap therebetween. A liquid crystal layer is sealed between the glass substrates. Polarizing plates are disposed on outer surfaces of the glass substrates.

As illustrated in FIG. 1, the backlight unit 30 includes at least LEDs 52, a light guide plate 60, optical sheets 33, and small LEDs 72. The LEDs 52 are an example of the first light source. The light guide plate 60 guide light from the LEDs 52. The optical sheets 33 exert predefined optical effects on the light exiting from the light guide plate 60. The small LEDs 72 are disposed behind the light guide plate 60 (on an opposite side from the liquid crystal panel 20). The small LEDs 72 are an example of second light sources. The backlight unit 30 includes a frame 15 and a chassis 40 (a backlight chassis). The frame 15 surrounds the light guide plate 60 and the optical sheets 33. The chassis 40 is disposed behind the frame 15. The chassis 40 houses the small LEDs 72. In this description, each of the small LEDs 72 has a light emitting surface 72A equal to or smaller than 1 mm².

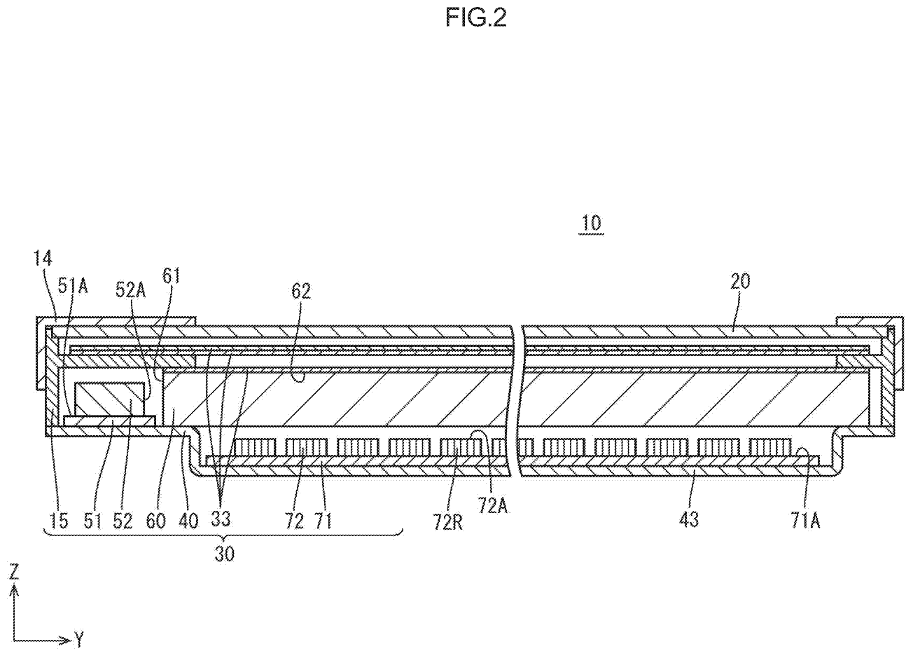

As illustrated in FIG. 1 and FIG. 2 (a cross-sectional view along line II-II in FIG. 1), the LEDs 52 are arranged at equal intervals in line on a surface (a mounting surface) an LED substrate 51. The LED substrate 51 has an elongated plate shape extending along one of long edges of the chassis 40. The LED substrate 51 is disposed adjacent to a first side surface 61 of the light guide plate 60. The LEDs 52 have a rectangular prism shape. The LEDs 52 include bottom surfaces that are disposed on the mounting surface 51A of the LED substrate 51 and side surfaces adjacent to the bottom surfaces defined as light emitting surfaces 52A. Namely, the LEDs 52 are side-emitting (side view) LEDs. Dimensions of each LED 52 may be defined as follows. A short dimension (in the Z-axis direction) of the light emitting surface 52A may be in a range from 1 mm to 3 mm. A long dimension (in the X-axis direction) of the light emitting surface 52A may be in a range from 4 mm to 5 mm. An area of the light emitting surface 52A may be in a range from 4 mm² to 15 mm². A depth (in the Y-axis direction may be in a range from 1 mm to 2 mm. The LEDs 52 are white LEDs that emit white light. The LEDs 52 may include blue LED chips (blue light emitting elements) that emit light in a single color of blue and sealants in which phosphors (green phosphors, red phosphors) are dispersed. The blue LED chips are sealed by the sealants.

As illustrated in FIGS. 1 and 2, the light guide plate 60 has a horizontally-long rectangular shape in a plan view similar to the liquid crystal panel 20. The light guide plate 60 has a thickness larger than the optical sheets 33. The light guide plate 60 is made of a substantially transparent synthetic resin material having a refractive index sufficiently higher than that of air (e.g., an acrylic resin such as PMMA or a polycarbonate). The light guide plate 60 receives the light from the LEDs 52 (emitted in the Y-axis direction) through the first side surface 61 opposed to the LEDs 52, transmits the light, entering through the first side surface 61 therethrough, and guides the light toward the optical sheets 33 such that the light exits through the front surface (a light exiting plate surface 62) on the front side.

The optical sheets 33 have flexibility. As illustrated in FIGS. 1 and 2, the optical sheets 33 have a horizontally-long rectangular shape in the plan view similar to the liquid crystal panel 20. The optical sheets 33 include a diffuser sheet and a light collecting sheet (a prism sheet) disposed on top of each other. The optical sheets 33 are disposed between the liquid crystal panel 20 and the light guide plate 60 to exert the predefined optical effects on the light exiting from the, light guide plate 60. The light travels through the optical sheets and exits toward the liquid crystal panel 20.

The chassis 40 is made of metal or resin. As illustrated in FIGS. 1 and 2, the chassis 40 has a plate shape and includes a recess 43 that is recessed toward the back of the chassis 40. The recess 43 is located in the middle recess 43 has a rectangular box shape to house a small LED substrate (an example of a second light source substrate) on which the small LEDs 72 are mounted.

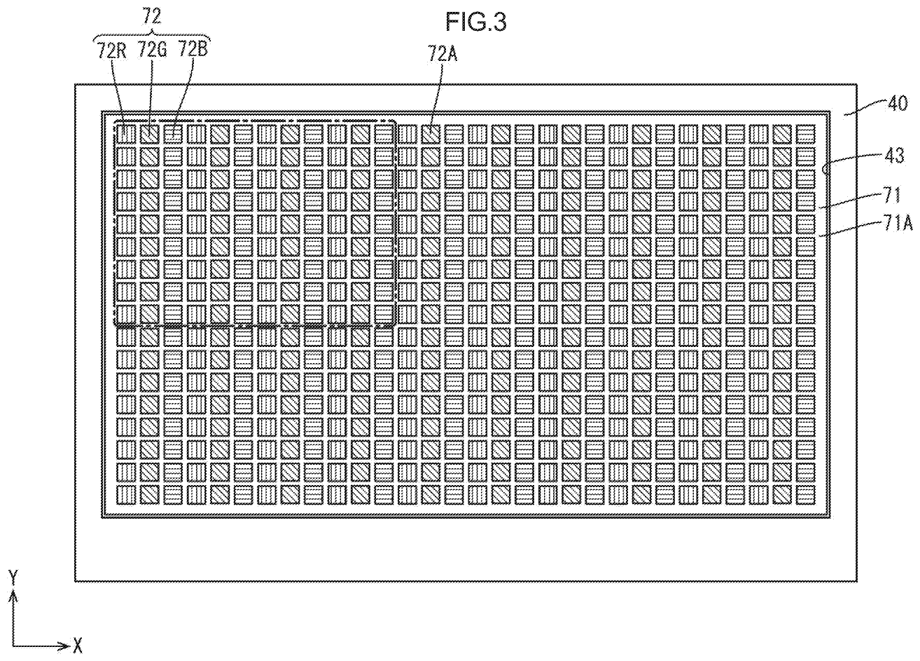

As illustrated in FIG. 1, the small LEDs 72 are two-dimensionally arranged behind the light guide plate 60 (on an opposite side from the light exiting plate surface 62) and mounted on a small LED substrate 71 (an example of the second light source substrate). The small LED substrate 71 has a rectangular shape. As illustrated in FIG. 2, the small LED substrate 71 is housed in the recess 43 of the chassis 40. As illustrated in a plan view in FIG. 3, the small LEDs 72 are arranged at substantially equal intervals in the horizontal direction (the X-axis direction, a row direction) and the vertical direction (the Y-axis direction, a column direction) to form a grid (a matrix) on a plate surface mounting surface 71A) of the small LED substrate 71. The mounting surface 71A of the small LED substrate 71 has light reflectivity. The light that leaks to the back of the light guide plate 60 is reflected by the mounting surface 71A to enter the light guide plate 60. The mounting surface 71A may be coated with white paint through silk printing or coating to have the light reflectivity. Alternatively, the mounting surface 71A may be coated with silver (Ag) or aluminum (Al) through vapor deposition to have the light reflectivity.

Each small LED 72 has a rectangular prism shape. The small LEDs 72 include bottom surfaces disposed on the mounting surface 71A and top surfaces on an opposite side from the bottom surface defined as light emitting surfaces 72A. Namely, the small LEDs 72 are top-emitting LEDs (top view LEDs). As illustrated earlier, an area of the light emitting surface 72A of each small LED 72 is defined equal to or smaller than 1 mm². In this embodiment, the light emitting surface 72A of each small LED 72 has the area of 1 mm×1 mm, that is, 1 mm². Each small LED 72 has a height in a range from 0.8 mm to 1 mm. The area of the light emitting surface 52A of each LED 52 is in the range from 4 mm² to 15 mm². The area of the light emitting surface of each small LED 72 is about 1/15 to ¼ of the area of the light, emitting surface 52A.

The small LEDs 72 include single-color LED chips that emit light in a single color and sealants made of a transparent resin material that does not contain phosphors. This embodiment includes three different types of single-color LED chips that emit light in different colors. Specifically, this embodiment includes the same number of red LED chips 72R (an example of a red light emitting type), green LED chips 72G (an example of a green light emitting type), and blue LED chips 72B (an example of a blue light emitting type).

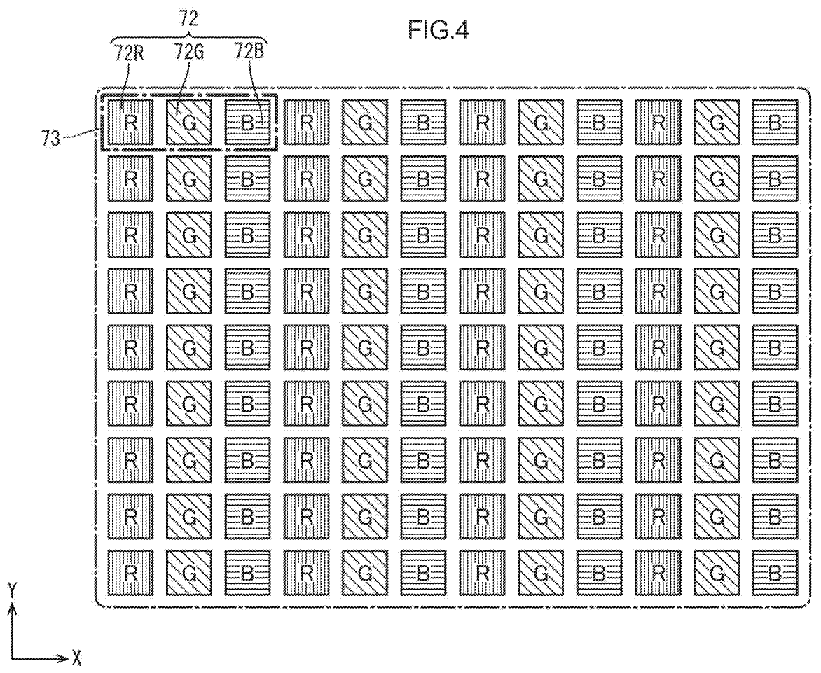

As illustrated in FIG. 3 and FIG. 4 (a magnified view of a section of FIG. 3), the LED chips that emit light in the same color are arranged in lines in the vertical direction (the Y-axis direction). More specifically, the red LED chips 72R are arranged in lines, the green LED chips 72G are arranged in lines, and the blue LED chips 72B are arranged in lines. The lines are repeatedly arranged in the horizontal direction (the X-axis direction) (this arrangement may be referred to as a vertical stripes arrangement). Every three of the small LEDs 72 that are consecutively arranged in the horizontal direction form a light source group 73. The light source group 73 includes one red LED chip 72R, one green LED chip 72G, and one blue LED chip 72B. It is preferable that the small LEDs 72 arc arranged such that each light source group 73 including three small LEDs 72 that are consecutively arranged in at least one of the horizontal direction and the vertical direction includes one red LED chip 72R, the green LED chip 72G, and the blue LED chip 72B.

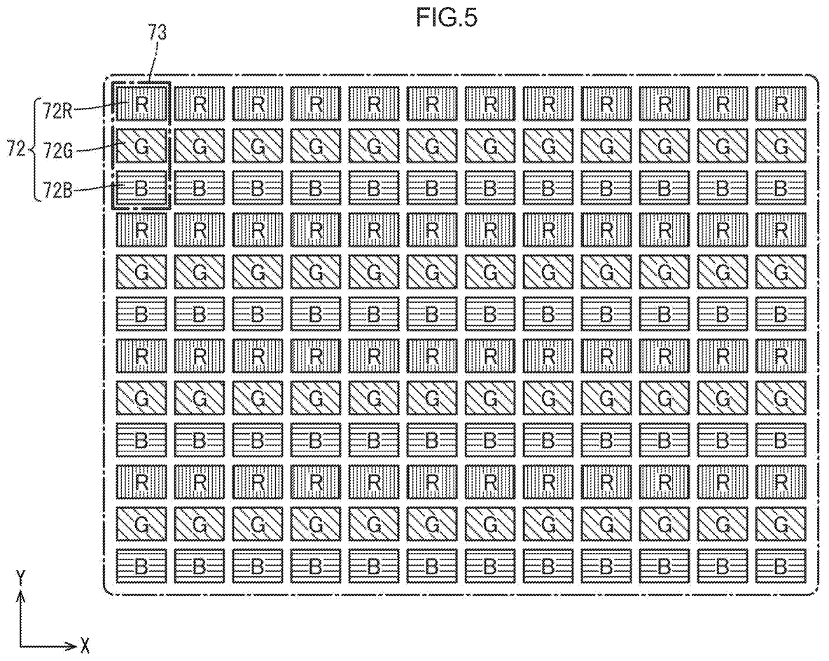

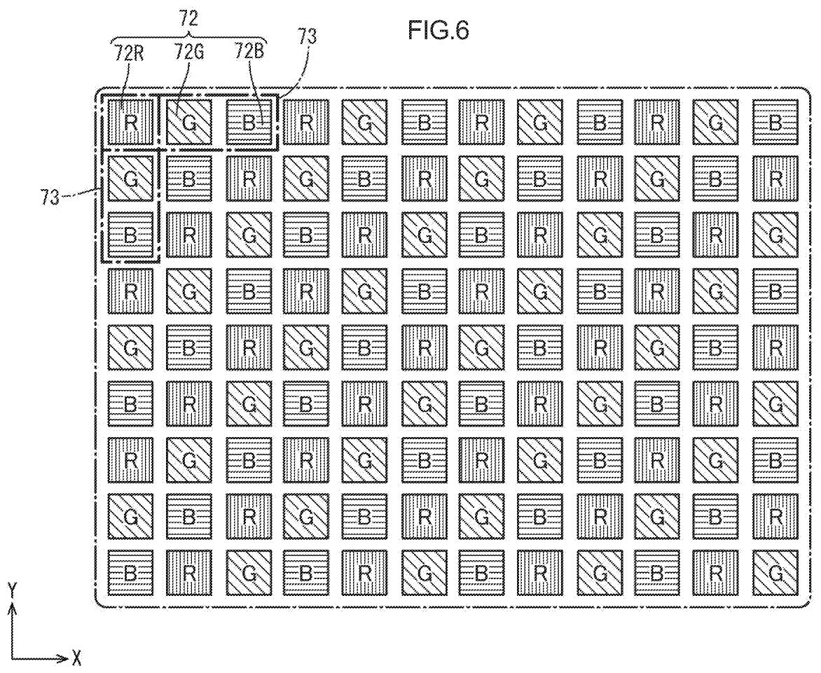

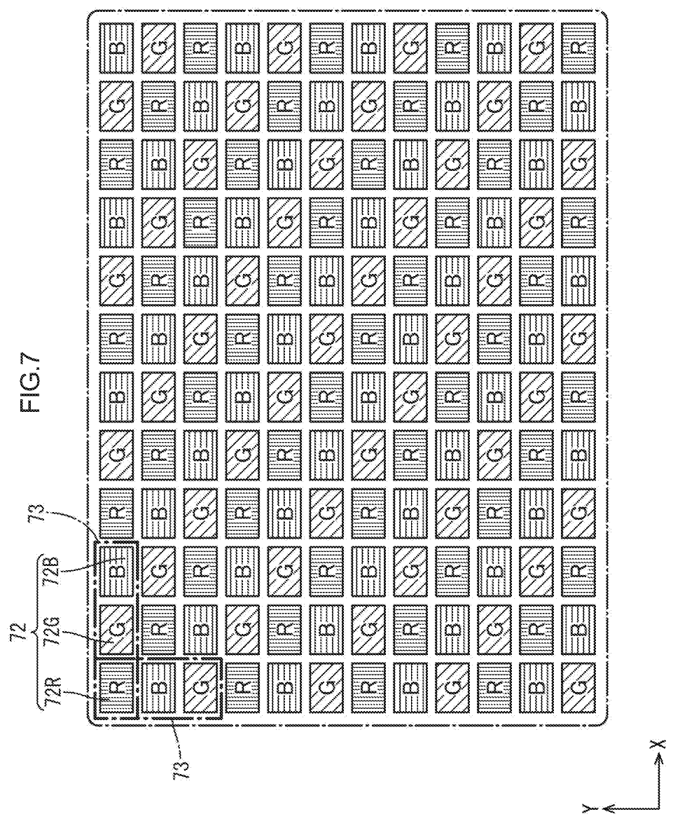

Examples of the arrangements include horizontal stripes arrangements (a first modification) illustrated in FIG. 5 and zigzag arrangements (a second modification illustrated in FIG. 6, a third modification) illustrated in FIG. 7. In the horizontal stripes arrangement in the first, modification illustrated in FIG. 5, the red LED chips 72R are horizontally arranged in lines, the green LED chips 72G are horizontally arranged in lines, and the blue LED chips 72B are horizontally arranged in lines. The lines are repeatedly arranged in the vertical direction. In the zigzag arrangement according to the second modification illustrated in FIG. 6, the red LED chips 72R, the green LED chips 72G, and the blue LED chips 72B are repeatedly arranged in this sequence in the horizontal direction and the vertical direction. In the zigzag arrangement according to the third modification illustrated in FIG. 7, the red LED chips 72R, the green LED chips 72G, and the blue LED chips 72B are repeatedly arranged in this sequence in the horizontal direction and the LED chips 72R, the blue LED chips 72B, and the green LED chips 72G are repeatedly arranged in this sequence.

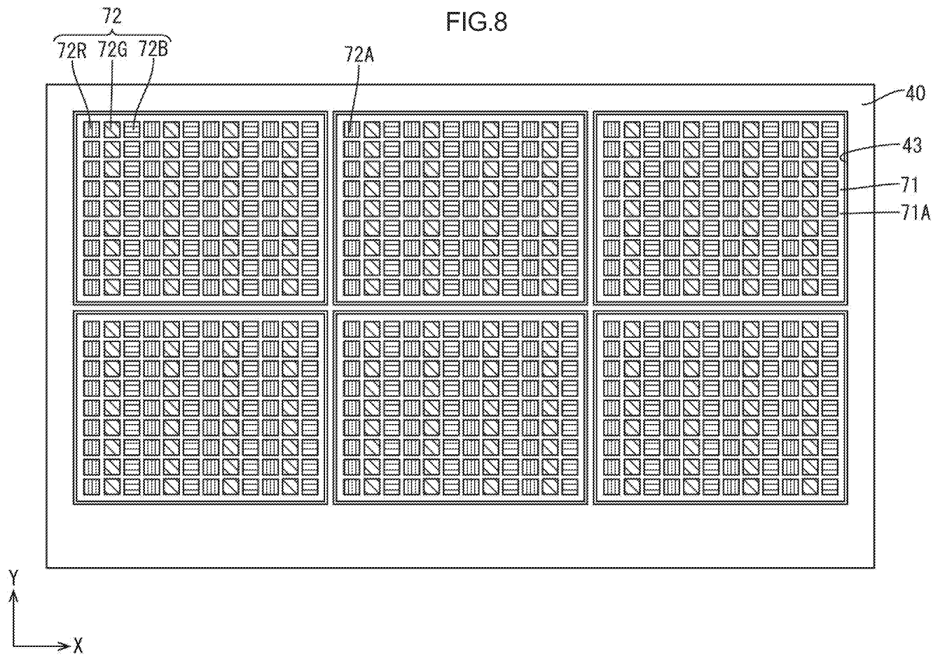

The arrangement of the small LEDs 72 is on a single small LED substrate 73. As in a fourth modification illustrated in FIG. 8, the small LEDs 72 may be provided in predefined arrangements on multiple small LED substrates 71 (six substrates in FIG. 8). With the multiple small LED substrates 71, a larger number of the small LEDs 72 can be mounted. This configuration is preferable for providing the liquid crystal display device 10 with a large screen.

As described above, the backlight unit 30 in this embodiment includes the LEDs 52, the light guide plate 60, and the small LEDs 72. The light guide plate 60 includes the first side surface 61 opposed to the LEDs 52 and the light exiting plate surface 62. The light, from the LEDs 52 enters the first side surface 61, travels through the light guide plate 60, and exits through the light exiting plate surface 62. The small LEDs 72 are two-dimensionally arranged on the opposite side from the light exiting plate surface of the light, guide plate 60. Each small LED 72 includes the light emitting surface, the area of which is equal to or smaller than the area of the light emitting surface of the each LED 52.

According to the configuration, the light emitted by the LEDs 52 enters the light guide plate 60 through the first side surface 61 and the light emitted by the small LEDs 72 enters the light guide plate 60 through the back surface. The light from the LEDs 52 and the light from the small LEDs 72 are added together. Therefore, brightness of the light emitted by the backlight unit 30 is higher in comparison to a configuration that includes only the LEDs 52 or the small LEDs 72. This configuration improves the brightness. The area of the light emitting surface 72A of each small LED 72 is equal to or smaller than the area of the light emitting surface 52A of each LED 52. With the small LEDs 72 that are two-dimensionally arranged behind the light guide plate 60, the brightness within the plane can be precisely adjusted. Because the precise brightness adjustment is available (local dimming is available) in the backlight unit 30, the liquid crystal display device 10 can be provided with high contrast and high quality.

The area of the light emitting surface of each small LED 72 in this embodiment is equal to or smaller than 1.0 mm². With the small LEDs 72 having such a configuration, the backlight unit 30 can be easily configured as described above.

The small LEDs 72 in this embodiment include the red LED chips 72R, the green LED chips 72G, and the blue LED chips 72D. The small LEDs 72 include the same number of the different color types of the small LEDs 72. With the red LED chips 72R, the green LED chips 72G, and the blue LED chips 72B, light in false white is produced. Turn-on and turn-off of the small LEDs 72 that emit light in different colors can be individually controlled. Therefore, the backlight unit 30 can emit reddish white light, greenish white light, or bluish white light. With the backlight unit 30 installed in the liquid crystal display device 10, the wider color gamut is provided and the color reproducibility is improved.

The small LEDs 72 in this embodiment, are arranged in the grid on the small LED substrate 71. Each of the light source groups 73 includes three small LEDs 72 that are consecutively arranged in at least one of the vertical direction and the horizontal direction. The three small LEDs 72 includes one red LED chip 72R, one green LED chip 72G, and one blue LED chip 72B. According to the arrangement, the light, in false white can be properly produced.

The mounting surface 71A of the small LED substrate 71 In this embodiment, has the light reflectivity. According to the configuration, the light that leaks to the back of the light, guide plate 60 is reflected by the mounting surface 71A to enter the light guide plate 60. According to the configuration, the brightness further improves. The conventional edge light, type backlight unit (including only the LEDs 52, which are included in the first, light sources) includes the reflection sheet disposed behind the light guide plate 60 to reflect the light that leaks to the back of the light guide plate 60. According to the configuration described above, the reflection sheet is not, required. The reflection sheet may result in uneven brightness due to wrinkles and sags. Without the reflection sheet, it is not necessary to consider the uneven brightness resulting from the reflection sheet.

### Second Embodiment

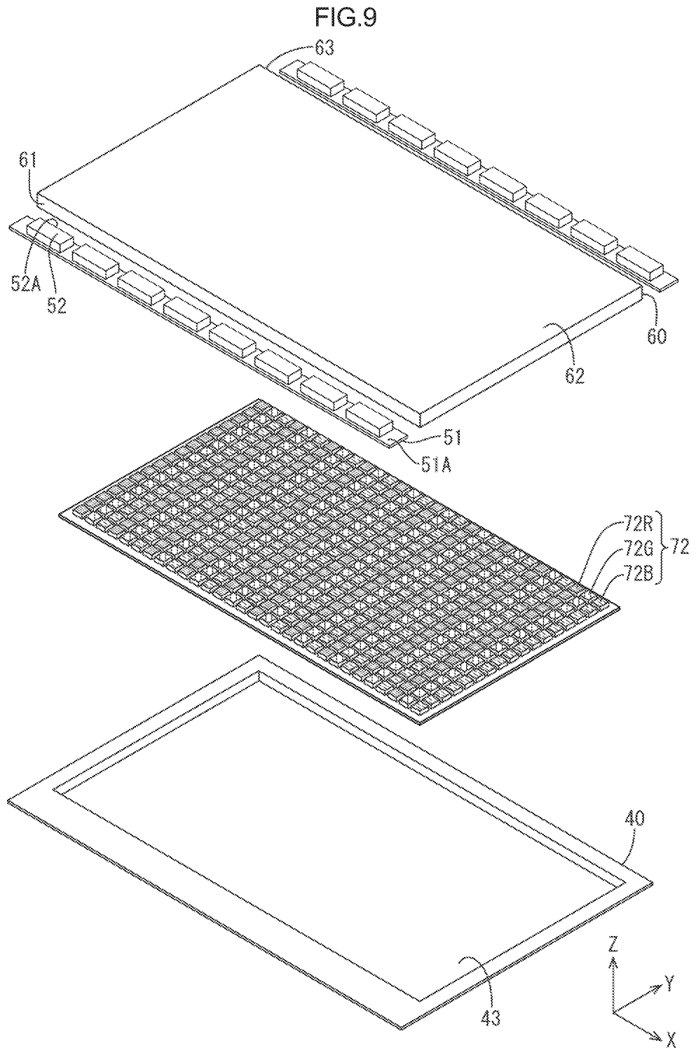

A second embodiment of the technology described herein will be described with reference to FIG. 9. In the second embodiment, the LEDs 52, which are included in the first light sources, arc disposed opposite either side surface of the light guide plate 60. Components, functions, and effects similar to those of the first embodiment previously described will not be described.

As illustrated in FIG. 9, the LEDs 52 are disposed opposite the first side surface 61 of the light guide plate 60 and the second side surface 63 of the light guide plate 60 on an opposite side from the first side surface 61. The light emitted by the LEDs 52 enters the light guide plate 60 through the side surfaces 61 and 63 of the light guide plate 60. According to the configuration, the brightness further improves. This configuration is preferable for achieving uniform brightness distribution.

### Third Embodiment

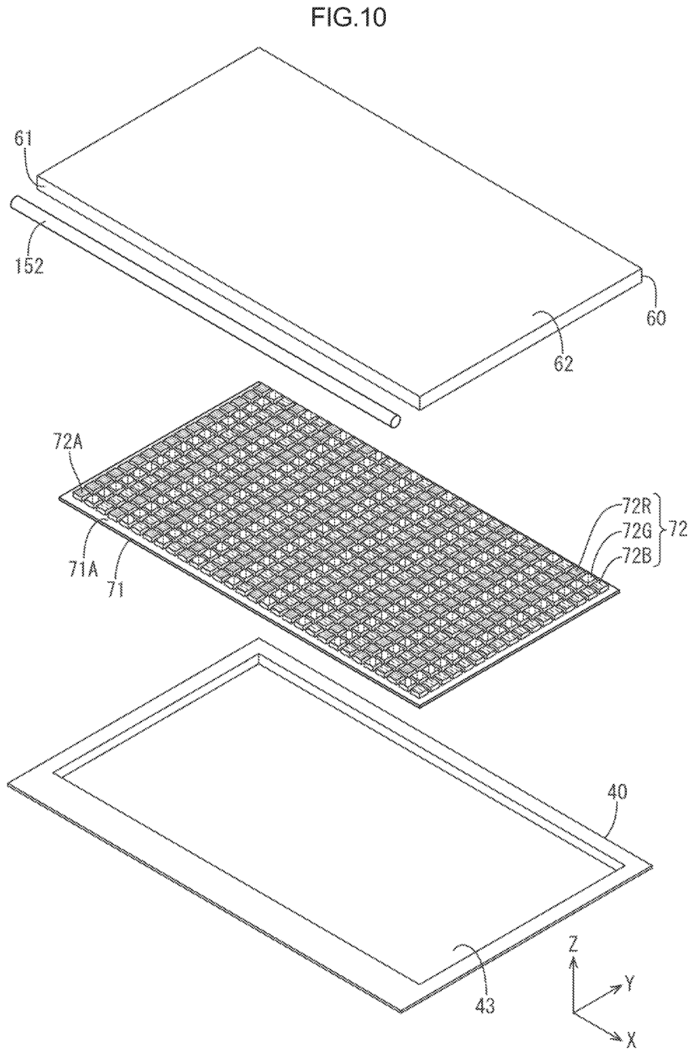

A third embodiment, of the technology described herein will be described with reference to FIG. 10. The third embodiment includes a cold cathode fluorescent lamp (CCFL) 152 provides as a first light source. Components, functions, and effects similar to those of the first embodiment previously described will not foe described.

As illustrated in FIG. 10, the cold cathode fluorescent lamp 152 is disposed opposite the first side surface 61 of the light guide plate 60 in this embodiment. The cold cathode fluorescent lump 152 is supported by the chassis 40 with clips. The cold cathode fluorescent lamp 152 has a diameter about equal to a height of the first side surface in the Z-axis direction (about 1 mm to 3 mm in this embodiment). The cold cathode fluorescent lamp 152 has a length about equal to the length of the first side surface in the X-axis direction. The cold cathode fluorescent lamp 152 is less expensive in comparison to the LEDs 52. With the cold cathode fluorescent lamp 152 used for the first light source, a cost can be reduced.

### Fourth Embodiment

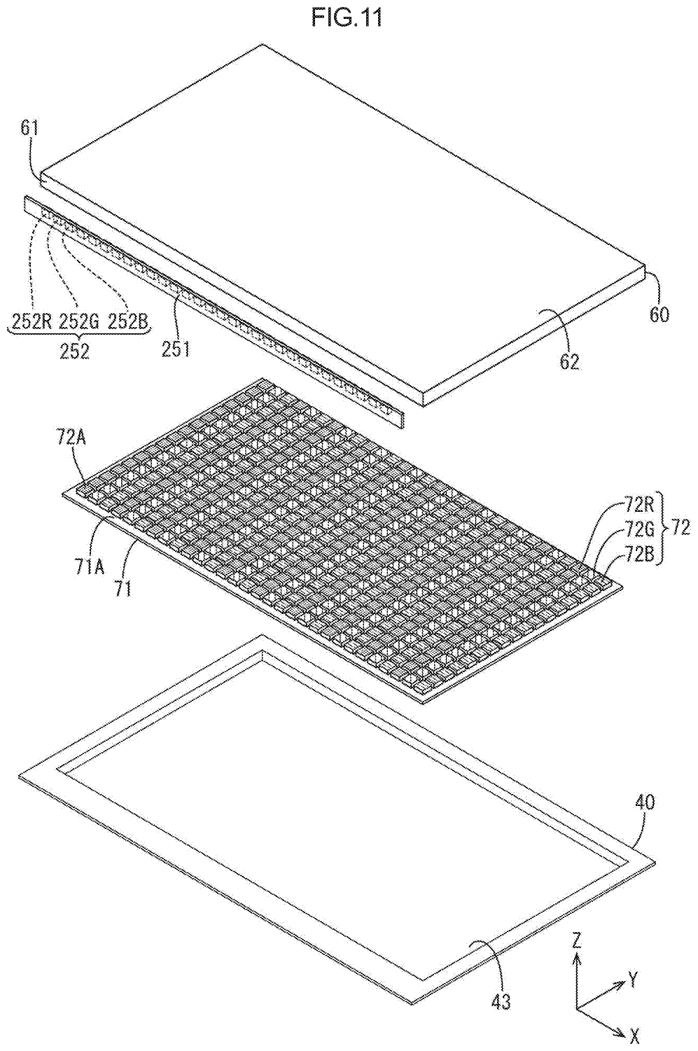

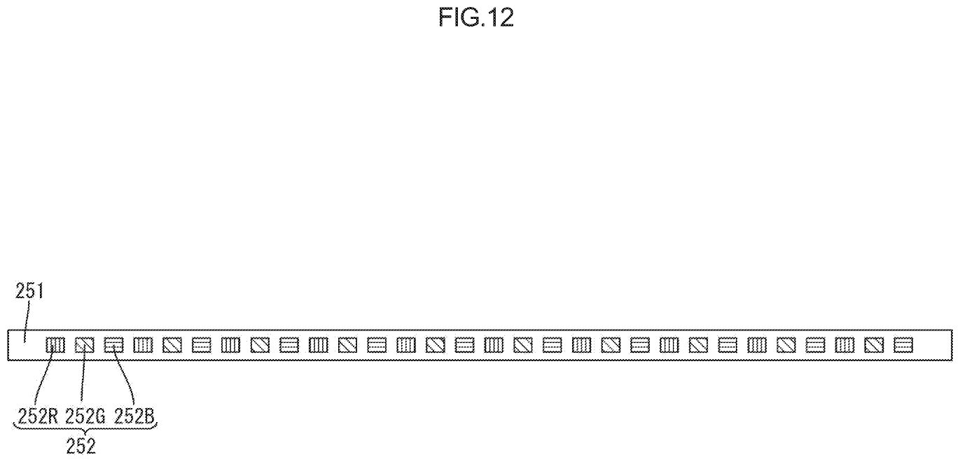

A fourth embodiment of the technology described herein will be described with reference to FIGS. 11 and 12. The fourth embodiment includes small LEDs 252 for the first light source. The small LEDs 255 have the same configuration as that of the second light sources. Components, functions, and effects similar to those of the first to the third embodiments previously described will not be described.

As illustrated in FIG. 11, the small LEDs 252 are disposed opposite the first side surface 61 of the light guide plate 60. The small LEDs 252 are top-emitting LEDs. Each small LED 252 has a light emitting surface 252A having an area of 1 mm² or smaller similar to the small LEDs 72 used for the second light sources. As illustrated in FIGS. 11 and 12, the small LEDs 252 are arranged at equal intervals in line on a surface (a mounting surface) of a small LED substrate 251. The small LEDs 257 include red LED chips 252R, green LED chips 2520, and blue LED chips 252B similar to the small LEDs 72 used for the second light sources. The red LED chips 252R, green LED chips 252G, and blue LED chips 252B are arranged in sequence. With the red LED chips 252R, green LED chips 252G, and blue LED chips 252B, light in false white is produced.

### Other Embodiments

The technology described herein is not limited to the embodiments described above and illustrated by the drawings. For example, the following embodiments will be included in the technical scope of the technology described herein.

(1) In the first embodiment, the side-emitting LEDs are provides as an example of the first light sources. However, the top-emitting LEDs may be used. In each of the above embodiment, the LEDs, the small LEDs, or the cold cathode fluorescent lamp is used for the first light source. However, other types of light sources (e.g., organic ELs) may be used.

(2) In each of the above embodiments, the small LEDs include the red LED chips, the green LED chips, and the blue LED chips. However, white LEDs configured to emit white light may be used.

(3) In each of the above embodiments, the LEDs included in the first light source are arranged along the long side surface (the first side surface, the second side surface) of the light guide plate. However, the LEDs may be arranged along the short side surface.

1. A lighting device comprising:
at least one first light source;
a light guide plate including:
a first side surface opposed to the at least one first light source so that light from the light source enters therethrough; and
a light exiting plate surface through which the light entering through the first, side surface and traveling through the light guide plate exits;
second light sources two-dimensionally arranged on an opposite side from the light exiting plate surface of the light guide plate, the second light sources including light exiting surfaces each having an area equal to or smaller than an area of a light, emitting surface of the at least, one first, light source.

2. The lighting device according to claim 1, wherein the second light sources include small LEDs including light emitting surfaces having an area equal to or smaller than 10 mm².

3. The lighting device according to claim 1, wherein the second light sources include a same number of red light emitting light sources, green light emitting light sources, and blue light emitting light sources.

4. The lighting device according to claim 3, wherein
the second light sources are arranged in a grid on a second light source substrate,
every three of the second light sources consecutively arranged in at least one of a row direction and a column direction forms a light source group, and
the light source group includes one of the red light emitting light source, one of the green light emitting light sources, and one of the blue light emitting light sources.

5. The lighting device according to claim 4, wherein the second light source substrate includes a mounting surface having light reflectivity.

6. The lighting device according to claim 1, wherein the at least one first light source includes another first light source disposed opposite a second side surface on an opposite side from the first side surface.

7. The lighting device according to claim 1, further comprising an optical sheet disposed on an opposite side from the second light sources relative to the light guide plate to exert an optical effect on the light exiting from the light guide plate.

8. A display device comprising:
the lighting device according to claim 1; and
a display panel configured to display an image using light emitted by the lighting device.

9. The display device according to claim 8, wherein the display panel is a liquid crystal panel including liquid crystals.
